(19) United States
(12) Patent Application Publication
(10) Pub. No.: US 2018/0360289 A1
(43) Pub. Date: Dec. 20, 2018

(54) WIPE

(71) Applicant: Auroson Bystrom, Newport Beach, CA (US)

(72) Inventor: Auroson Bystrom, Newport Beach, CA (US)

(21) Appl. No.: 16/010,532

(22) Filed: Jun. 18, 2018

Related U.S. Application Data
(60) Provisional application No. 62/522,264, filed on Jun. 20, 2017.

(51) Int. Cl. A47L 13/17; A47K 10/16

(52) U.S. Cl. CPC A47L 13/17; B32B 7/045; A47K 10/16

(57) ABSTRACT

The claimed invention is a wipe that will have a double layer that is sealed on three sides but is left open on one. The wipe has a single pocket that can be turned inside out. Double layers of the wipe will help in cleaning surface and further a protective surface so that no contaminants can leak out.

### CROSS-REFERENCE TO RELATED APPLICATIONS

This non-provisional utility patent application claims priority filing benefit of U.S. Provisional Patent No. 62/522,264 filed on Jun. 20, 2017.

### BACKGROUND

### Copyright Notice

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### Field of the Invention

The present invention relates to wipes, baby pes, sanitary wipes, towelettes, dry wipes, and tissues but more particularly to an improved wet wipe or towelette for personal hygiene.

### Description of the Related Art

Wipes can serve a number of purposes from personal hygiene, on the sensitive skin of babies, medical pain relief for treating minor scrapes and burns to alcohol-based wipes for disinfection, cleansing pads for eyes, ears and dental applications, industrial cleaning applications and as a luxury option to toilet paper etc. Wipes are generally made from materials such as cotton, wood pulp, polyester or rayon fibers formed into sheets.

However, to the Applicant's knowledge, none of these prior art methods have been found to contain a pocket used in conjunction with the wipe. It is thus desirable to provide disposable wipe products made so as to contain a pocket. The present invention provides such a method and the overall combination of these features is nowhere disclosed in the prior art cited above which appears to be representative of the general art in this area although it is not intended to be an all-inclusive listing of pertinent prior art patents.

### SUMMARY

In light of the disadvantages of the prior art, the following summary is provided to facilitate an understanding of some of the innovative features unique to the present invention and is not intended to be a full description. A full appreciation of the various aspects of the invention can be gained by taking the entire specification, claims, drawings, and abstract as a whole.

It is main advantage of this invention to provide for a means of holding disposables within a wipe in order to effect easy disposal of the resulting combination in the trash or garbage.

Another non-limiting embodiment of the present invention is that any item can be picked up and enclosed in the wipe's pocket by turning the wipe inside out without the user's hand coming into contact with the said waste item.

It is another advantage of this invention that it has one (or more) pockets such that the pocket(s) does not interfere with the inherent functional characteristics of the wipes.

It is a further advantage of this invention that the pocket(s) could comprise the entirety or a portion of the wipe. The pockets can be created in a number of ways to suit manufacturing ease, by joining/fusing ends or sides, providing a slit between layers, fusing wipes together, folding one side or corner partially etc.

In order to do so, the invention in a preferred embodiment is in the form of a wipe sheet (or multiple sheets/layers) as can be seen in figures. One or more pockets are formed by folding a wipe sheet in different ways and joining select sides and/or corners. Additionally, pockets can be formed by joining wipe sheets together or by creating a pocket between layers of sheets that form the wipe.

This disposable wipe will have a double layer that is sealed on two or three sides but is left open on one. Once it is used for wiping, for instance wiping a children's hands after they eat a plum, the plum pit can be picked up using the wipe and the entire wipe can be folded inside out, with the dirty side folded away and the plum pit now resting inside the pocket, or the plum pit can be easily inserted into the said pocket. Hence the plum pit can be held or carried without dirtying or contaminating its surroundings.

Another embodiment of the invention is that the wipe can be turned inside out and the soiled surface would remain inside.

Double or more of layers of material that could have a cleaning layer and a protective layer so that no contaminants can leak out.

A new improvement on wipe where it has a single pocket that covers either the whole sheet or a portion of it.

Numerous other embodiments are also possible. For example, the materials used, the method of joining/fusing sides, the size of the wipes layers used and shape etc. The functionality can be applied to baby wipes, adult wipes, incontinence wipes, intimate wipes, sanitary wipes, cleaning wipes, make-up removal wipes, disposable wipes, organic wipes, floor wipes, industrial wipes, dry wipes, and other such wipes. Accordingly, the drawings and description are to be regarded as illustrative in nature, and not as restrictive.

This Summary is provided merely for purposes of summarizing some example embodiments, so as to provide a basic understanding of some aspects of the subject matter described herein. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention and explain various principles and advantages of those embodiments.

FIGS. 1a and 1b is an exemplary embodiment of the proposed invention and shows two sheets of a various size covering the bottom layer partially or fully and sealed on Three sides.

FIGS. 2a and 2b is an exemplary embodiment of the proposed invention with one sheet folded on itself covering the bottom layer partially or fully and sealed on two sides.

FIG. 3a shows two sheets sealed on all four sides with a slit in one sheet so as to access the pocket and 3b shows a sheet folded at a corner and sealed on one side so as to make a triangular pocket.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

The following detailed description is merely exemplary in nature and is not intended to limit the described embodiments or the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure, which is defined by the claims. Furthermore, there is no intention to be bound by any expressed or implied theory presented in the preceding technical field, background, brief summary or the following detailed description. It is also to be understood that the specific devices and processes illustrated in the attached drawings, and described in the following specification, are simply exemplary embodiments of the inventive concepts defined in the appended claims. Specific dimensions and other physical characteristics relating to the embodiments disclosed herein are therefore not to be considered as limiting unless the claims expressly state otherwise.

A new improvement on wipe where it has a single pocket that covers either the whole sheet or a portion of it.

The sheet materials can be provided as thy sheets or moist sheets, The sheet materials can be further treated during or after the formation of the wipe product. Examples of treatments include embossing, cutting, folding, impregnation with additives, application of binders, application of moisture, and application of agents such as lotions, therapeutic substances, cleaning agents, and agents for sanitization and/or sterilization.

The wipe can be composed of numerous layers such as to provide a layer for cleaning and a further layer to act as a protective shield against leakage and or contamination between what is held inside the pocket and outside surfaces.

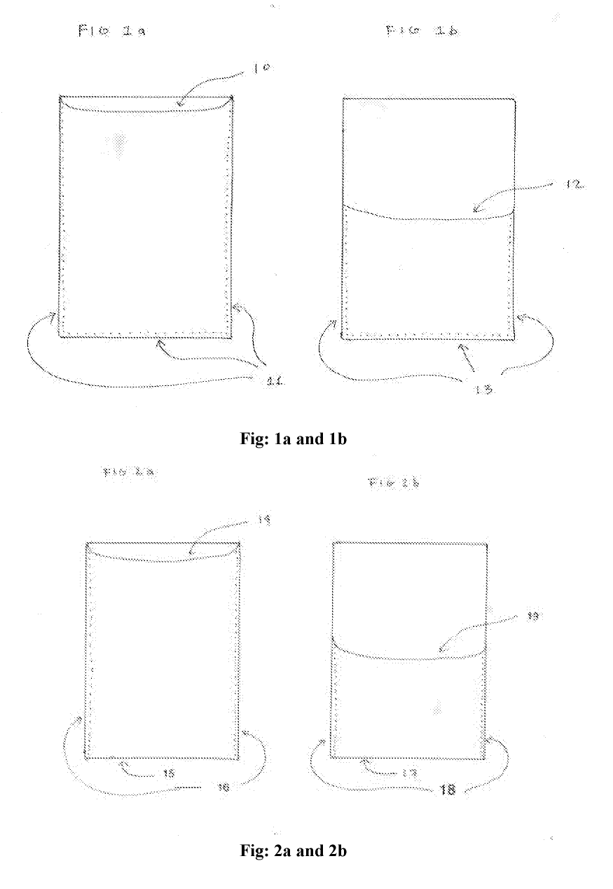

FIGS. 1a and 1b provides a schematic illustration of an example of some of the components of a wipe and the materials used, as well as an example of an end product. An improved wipe comprising of, in a preferred embodiment, a wiping sheet made up of two sheets layered on-top of each other and joined or sealed together fully or partially (11), (13) to form one or more pockets (10), (12).

FIGS. 2a and 2b shows wipe made up of one sheet folded (15), (17). And sealed, and/or which are joined (16), (18) thus creating a pocket (14), (19)

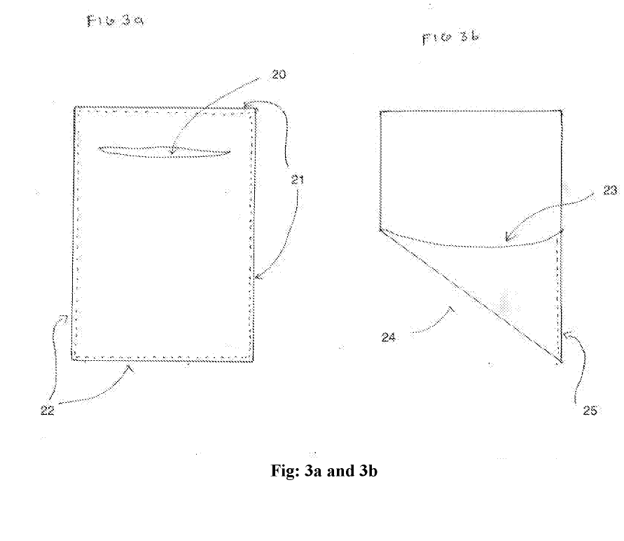

FIGS. 3a shows two sheets sealed (21), (22) with a slit or opening (20) in one sheet so as to access the pocket and 3b shows sheet folded (24) at a corner and sealed on one side (25) so as to make a triangular pocket (23).

Among the various uses this improved wipe can be used as a traditional ‘baby wipe’ as after cleaning, the wipe can be turned inside out and the soiled surface would remain inside. It is particularly useful for traveling, where one often needs wipes to clean oneself or the surrounding objects but also needs to deal with waste items such as chewing gum, when one is not near to a waste disposal. Another reason for wipes is for post intercourse cleaning, in this situation these multipurpose wipes can also be used to clean the genitals as well as disposing of condoms in a sanitary and discrete way after they have been used. This wipe makes it possible to carry waste items hygienically and out of sight. It is also useful for medical purposes where possibly contagious and uncleanly items such as bloody cotton balls or to clean a person and then enclose the feces, snot, spit or sputum can be kept in the wipe pocket and separated from other waste.

A simple functionality of wipe would be:

a Use the wipe to hold waste.

used to pick up waste without touching it and enclosing it inside the pocket

Turn inside out.

Wrap it and enclose the waste.

Dispose of the wipe.

Proposed places where the wipe can be used, but not limited to:

Improved baby wipe so that the soiled side may be turned inside out and isolated

Post sex to dispose of condoms.

Women using sanitary products such as tampons and sanitary pads.

While traveling for cleaning and garbage bag for food or any other waste. i.e. chewing gum/Food.

In dentistry to clean and or dispose of things such as teeth and or dentistry tools.

In medicine to clean surfaces and or people and or dispose of medical items.

In engineering or chemical situations where a surface needs to be cleaned and items disposed of without contact.

in a laboratory situation where items need to be efficiently picked up and disposed of.

It is noted that the simplified diagrams and drawings do not illustrate all the various connections and assemblies of the various components, however, those skilled in the art will understand how to implement such connections and assemblies, based on the illustrated components, figures, and descriptions provided herein, using sound engineering judgment.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

The invention is a Double layered wipe comprising:

1) One or more sheets or layers that are folded and/or joined in multiple ways to form one or more pockets; said pockets can take the entirety of the wipe or a portion thereof; said wipe used for holding disposables to be disposed of along with wipe after use.

2) The Wipe will have a double layer that is sealed on three sides but is left open from the last end, the dirty side folded away the wipe can be held or carried without dirtying or contaminating its surroundings.

3) It has a single pocket that can be turned inside out and covers either the whole sheet or a portion of it so to be used as a regular wipe or additionally one can use the pocket.
